(19) United States
(12) Patent Application Publication
(10) Pub. No.: US 2007/0085974 A1
(43) Pub. Date: Apr. 19, 2007

(54) PROJECTOR CAPABLE OF ILLUMINATING A CONNECTION INTERFACE THEREOF AND METHOD THEREOF

(76) Inventors: Shih-Hung Yu, Tao-Yuan Hsien (TW); Hung-Wen Liu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/470,621

(22) Filed: Sep. 6, 2006

(30) Foreign Application Priority Data
Oct. 13, 2005 (TW) 094135708

(51) Int. Cl. G03B 21/26

(52) U.S. Cl. 353/30

(57) ABSTRACT

A projector includes a housing, a projection module installed inside the housing, a connection interface installed on the housing for connecting external devices, and an illumination module installed on the housing for illuminating the connection interface. The projector further includes a switch installed on the housing for switching on the illumination module.

### BACKGROUND OF THE INVENTION

1. Field of the Invention

The present invention relates to a projector, and more particularly, to a projector capable of illuminating a connection interface thereof and method thereof.

2. Description of the Prior Art

Projectors are conventionally used in conference briefings in which the host projects data or graphics on a screen for familiarizing attendants with the current presentation. With the rapid development of technology, projectors have been widely used in other applications. With high power hi-fi equipment, large-sized digital video discs (DVDs) and the super-large images generated by a projector, it is now possible to reconstruct visual and acoustic effects similar to those provided in a movie theater at home.

Please refer to FIG. 1 . FIG. 1 is a perspective drawing of a projector 10 in the prior art. The projector 10 includes a housing 12 including a first side 14 and a second side 16, and a connection interface 18 positioned on the first side 14 of the housing 12. The connection interface 18 includes a plurality of sockets 20 for connecting external devices so as to receive image signals transmitted from the external devices, such as a computer device, an image output device, and so on. The projector 10 further includes a plurality of buttons 22 installed on the second side 16 of the housing 12 for providing users to input instructions to control the projector 10, such as switching on or switching off the projector 10, adjusting parameters of the projector 10, and so on. The using condition of the projector 10 is always dark so that it is inconvenient to connect cables to the connection interface 18.

### SUMMARY OF THE INVENTION

It is therefore a primary objective of the claimed invention to provide a projector capable of illuminating a connection interface thereof and method thereof for solving the above-mentioned problem.

According to the claimed invention, a projector includes a housing, a projection module installed inside the housing, a connection interface installed on the housing for connecting external devices, an illumination module installed on the housing for illuminating the connection interface, and a switch installed on the housing for switching on the illumination module.

According to the claimed invention, a projector includes a housing, a projection module installed inside the housing, a connection interface installed on the housing for connecting external devices, an illumination module installed on the housing for illuminating the connection interface, a switch installed on the housing for switching on the illumination module, a judging means for judging whether the projection module is projecting images when the switch is triggered, and a control means for controlling the illumination module according to a judging result of the judging means.

According to the claimed invention, a method for controlling an illumination module for illuminating a connection interface of a projector is disclosed. The method includes following steps: (a) judging whether a switch of the projector is triggered; (b) judging whether a projection module of the projector is projecting images; and (c) controlling the illumination module for illuminating the connection interface of the projector according to judging results in step (a) and step (b).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective drawing of a projector in the prior art.

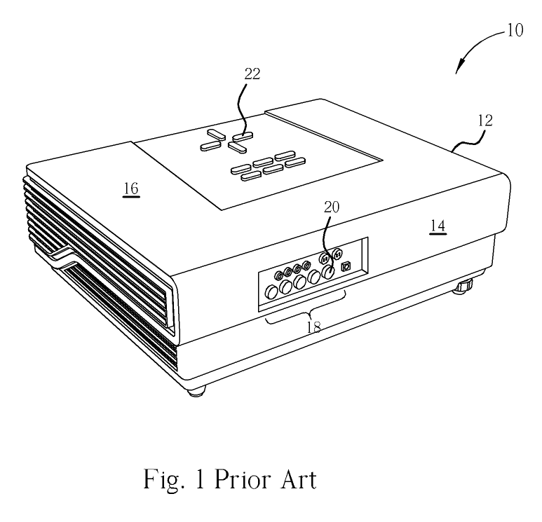

FIG. 2 is a perspective drawing of a projector according to the present invention.

FIG. 3 is a functional block diagram of the projector shown in FIG. 2 according to the present invention.

FIG. 4 is an enlarged diagram of a connection interface of the projector shown in FIG. 2 according to the present invention.

FIG. 5 is a flowchart of controlling an illumination module to illuminate the connection interface according to the present invention.

FIG. 6 is a functional block diagram of a projector of another embodiment according to the present invention.

### DETAILED DESCRIPTION

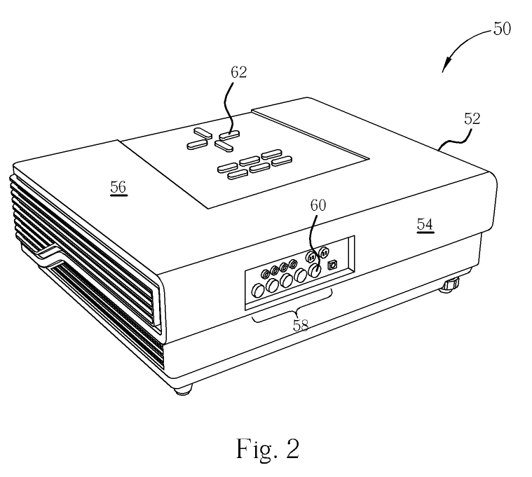

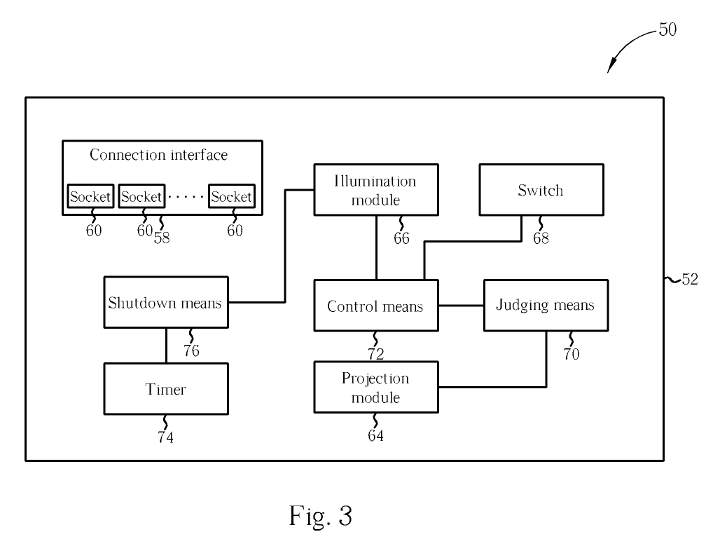

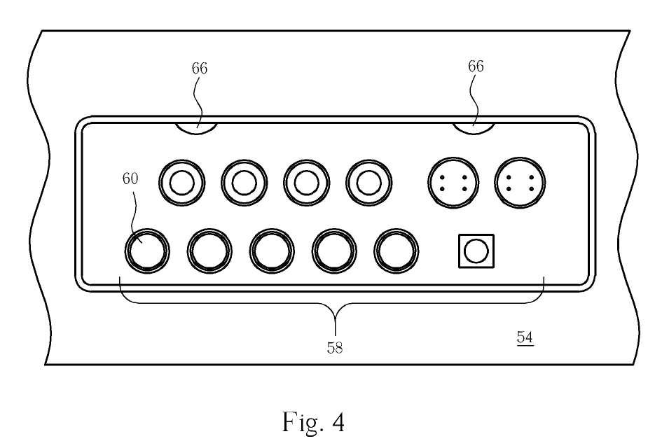

Please refer to FIG. 2 and FIG. 3. FIG. 2 is a perspective drawing of a projector 50 according to the present invention. FIG. 3 is a functional block diagram of the projector 50 according to the present invention. The projector 50 includes a housing 52 including a first side 54 and a second side 56, and a connection interface 58 positioned on the first side 54 of the housing 52. The connection interface 58 includes a plurality of sockets 60 for connecting external devices so as to receive image signals transmitted from the external devices, such as a computer device, an image output device, and so on. The projector 50 further includes a plurality of buttons 62 installed on the second side 56 of the housing 52 for providing users to input instructions to control the projector 50, such as switching on or switching off the projector 50, adjusting parameters of the projector 50, and so on. Please refer to FIG. 4 and FIG. 2. FIG. 4 is an enlarged diagram of the connection interface 58 of the projector 50 according to the present invention. The projector 50 further includes a projection module 64 installed inside the housing 52 for projecting images, and an illumination module 66 installed on the first side 54 of the housing 52 neighboring to the connection interface 58 for illuminating the connection module 58. The illumination module 66 can include a plurality of light-emitting diodes, a plurality of organic light-emitting diodes, an electroluminescent device, or a bulb. The projector 50 further includes a switch 68 installed on the second side 56 of the housing 52 for switching on the illumination module 66 for illuminating the connection module 58, a judging means 70 electrically connected to the projection module 64 for judging whether the projection module 64 is projecting images, and a control means 72 electrically connected to the illumination module 66, the switch 68, and the judging means 70 for controlling the illumination module 66 according to a judging result of judging means 70 and whether the switch 68 is triggered. The projector 50 further includes a timer 74 for counting time, and a shutdown means for switching off the illumination module 66 after the illumination module 66 is turned on for a predetermined period.

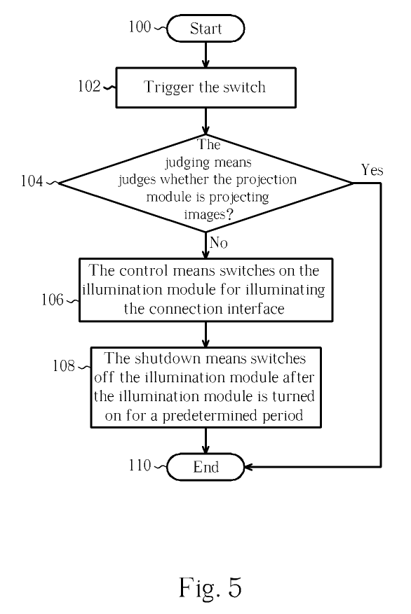

Please refer to FIG. 5. FIG. 5 is a flowchart of controlling the illumination module 66 to illuminate the connection interface 58 according to the present invention. The method includes following steps:

Step 100: Start.

Step 102: Trigger the switch 68.

Step 104: The judging means 70 judges whether the projection module 64 is projecting images. If the judging means 70 judges that the projection module 64 is not projecting images, go to step 106; if the judging means 70 judges that the projection module 64 is projecting images, go to step 110.

Step 106: When the judging means 70 judges that the projection module 64 is not projecting images, the control means 72 switches on the illumination module 66 for illuminating the connection interface 58.

Step 108: The shutdown means 76 switches off the illumination module 66 after the illumination module 66 is turned on for a predetermined period.

Step 110: End.

The detailed description is introduced as follows. The switch 68 can be designed to be the button 62 on the second side 56 of the housing 52. That is, besides the original function corresponding to the button 62, the button 62 is further capable of switching on the illumination module 66. In addition, the switch 68 can be designed to be a touch switch on the second side 56 of the housing 52. The touch switch can be a capacitive touch switch, a resistive touch switch, a surface acoustic wave touch switch, an infrared touch switch, a magnetic touch switch, and so on. That is, when the user touches the second side 56 of the housing 52, the switch 68 is triggered. Furthermore, the switch 68 is capable of switching off the illumination module 66 when the user touches the second side 56 of the housing 52 again. The present invention also can utilize the switch 68 to switch on or switch off the illumination module 66 directly without depending on any judging results. After the switch 68 is triggered, the judging means 70 judges whether the projection module 64 is projecting images. When the projection module 64 is projecting images, light emitted from the projection module 64 can illuminate surroundings of the projector 50. There is no need to switch on the illumination module 66 for illuminating the connection interface 58. When the projection module 64 is not projecting images, there is not enough light for illuminating the connection interface 58. The control means 72 will switch on the illumination module 66 for illuminating the connection interface 58.

As mentioned above, the illumination module 66 can be switched off by touching the second side 56 of the housing 52 again so as to control the switch 68 to switch off the illumination module 66 or by pressing the button 62 again so as to control the switch 68 to switch off the illumination module 66. Furthermore, the shutdown means 76 can switch off the illumination module 66 automatically after the illumination module 66 is turned on for the predetermined period. The lasting period that the illumination module 66 is open is calculated by the timer 74. The predetermined period can be set up before the projector 50 leaves the factory or by utilizing the button 62 in an OSD (on screen display) method.

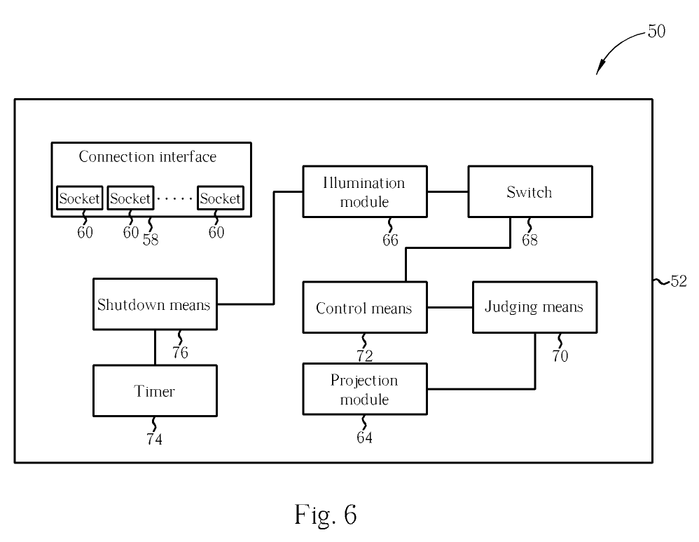

Please refer to FIG. 6. FIG. 6 is a functional block diagram of a projector 80 of another embodiment according to the present invention. The difference between the above-mentioned embodiment and this embodiment is that the switch 68 of the projector 80 is electrically connected to the illumination module 66 and the control means 72 of this embodiment and the control means 72 of the projector 50 is electrically connected to the illumination module 66 directly of the above-mentioned embodiment. When the judging means 70 judges that the projection module 64 is projecting images, the control means 72 disables the switch 68. That is, the illumination module 66 can not be switched on by triggering the switch 68 in this condition. If the button 62 is designed to be the switch 58, the control means 72 can control the button 62 to operate a function besides switching on the illumination module 66 such as switching on or switching off the projector 50 or adjusting parameters of the projector 50 when the judge means 70 judges that the projection module 64 is projecting images. On the other hand, when the judge means 70 judges that the projection module 64 is not projecting image, the control means 72 can not disable the switch 68. That is, the illumination module 66 can be switched on by triggering the switch 68 in this condition. If the button 62 is designed to be the switch 58, the control means 72 can control the button 62 to switch on the illumination module 66 or operate its original function simultaneously when the judge means 70 judges that the projection module 64 is not projecting images.

In contrast with the conventional projector, the projector according to the present invention can utilize the button or housing to be a switch for switching on the illumination module to illuminate the connection interface neighboring to the illumination module. The user can touch the button or the housing at hand first for switching on the illumination module to illuminate the connection interface when connecting cables to the connection interface or disconnecting cables from the connection interface. It provides a user-friendly application to the projector.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projector comprising:
a housing;
a projection module installed inside the housing;
a connection interface installed on the housing for connecting external devices;
an illumination module installed on the housing for illuminating the connection interface; and
a switch installed on the housing for switching on the illumination module.

2. The projector of claim 1 wherein the switch is capable of operating a function besides switching on the illumination module.

3. The projector of claim 2 wherein the switch is capable of switching on or switching off the projector.

4. The projector of claim 2 wherein the switch is capable of adjusting parameters of the projector.

5. The projector of claim 2 wherein the switch is capable of operating a function besides switching on the illumination module when the projection module is projecting images.

6. The projector of claim 1 wherein the switch is capable of switching on the illumination module when the projection module is not projecting images.

7. The projector of claim 1 further comprising:
a judging means for judging whether the projection module is projecting images; and
a control means for controlling the illumination module according to a judging result of the judging means.

8. The projector of claim 1 further comprising:
a timer for counting time; and
a shutdown means for switching off the illumination module after the illumination module is turned on for a predetermined period.

9. A projector comprising:
a housing;
a projection module installed inside the housing;
a connection interface installed on the housing for connecting external devices;
an illumination module installed on the housing for illuminating the connection interface;
a switch installed on the housing for switching on the illumination module;
a judging means for judging whether the projection module is projecting images when the switch is triggered; and
a control means for controlling the illumination module according to a judging result of the judging means.

10. The projector of claim 9 wherein the switch is a button.

11. The projector of claim 10 wherein the button is capable of operating a function besides switching on the illumination module.

12. The projector of claim 11 wherein the button is capable of switching on or switching off the projector.

13. The projector of claim 11 wherein the button is capable of adjusting parameters of the projector.

14. The projector of claim 11 wherein the button is capable of operating a function besides switching on the illumination module when the projection module is projecting images.

15. The projector of claim 10 wherein the button is capable of switching on the illumination module when the projection module is not projecting images.

16. The projector of claim 9 wherein the switch is a touch switch.

17. The projector of claim 9 further comprising:
a timer for counting time; and
a shutdown means for switching off the illumination module after the illumination module is turned on for a predetermined period.

18. A method for controlling an illumination module for illuminating a connection interface of a projector, the method comprising:
(a) judging whether a switch of the projector is triggered;
(b) judging whether a projection module of the projector is projecting images; and
(c) controlling the illumination module for illuminating the connection interface of the projector according to judging results in step (a) and step (b).

19. The method of claim 18 further comprising when judging the switch is triggered and the projection module is not projecting images, switching on the illumination module for illuminating the connection interface.

20. The method of claim 18 further comprising switching off the illumination module after the illumination module is turned on for a predetermined period.
